(19) United States
(12) Patent Application Publication
(10) Pub. No.: US 2004/0129469 A1
(43) Pub. Date: Jul. 8, 2004

(54) Self-propelled suitcase

(76) Inventor: Sarteep Kader, Middlesex (GB)

Correspondence Address: DOWELL & DOWELL PC, SUITE 309, 1215 JEFFERSON DAVIS HIGHWAY, ARLINGTON, VA, 22202

(21) Appl. No.: 10/473,407

(22) PCT Filed: Mar. 30, 2001
(86) PCT No.: PCT/GB01/01462

(51) Int. Cl. B62D 1/24

(52) U.S. Cl. 180/167

(57) ABSTRACT

A self-propelled suitcase comprising a storage compartment (2), a plurality of wheels (7), means (8, 11, 12) for driving at least one wheel, a sensor (20) for sensing a transmitted signal, means (10) for guiding the suitcase toward the source of the transmitted signal, and a separate signal transmitter (21) to be carried by the user for transmitting a signal to be detected by the sensor, whereby the suitcase will follow the user.

This invention relates to a self-propelled remote controlled suitcase.

A problem with suitcases is that they can be tiring to carry long distances. It has been proposed to make suitcases self propelled but no sensible way has been provided for controlling such a suitcase without continuous manual control.

The invention seeks to reduce this problem.

According to the invention there is provided a self-propelled suitcase comprising:

i) a storage compartment

ii) a plurality of wheels

iii) means for driving at least one wheel

iv) a sensor for sensing a transmitted signal

v) means for guiding the suitcase toward the source of the transmitted signal.

vi) a separate signal transmitter for transmitting a signal to be detected by the sensor.

Embodiments of the invention will be illustrated by way of nonlimiting example by reference to the accompanying figures in which:

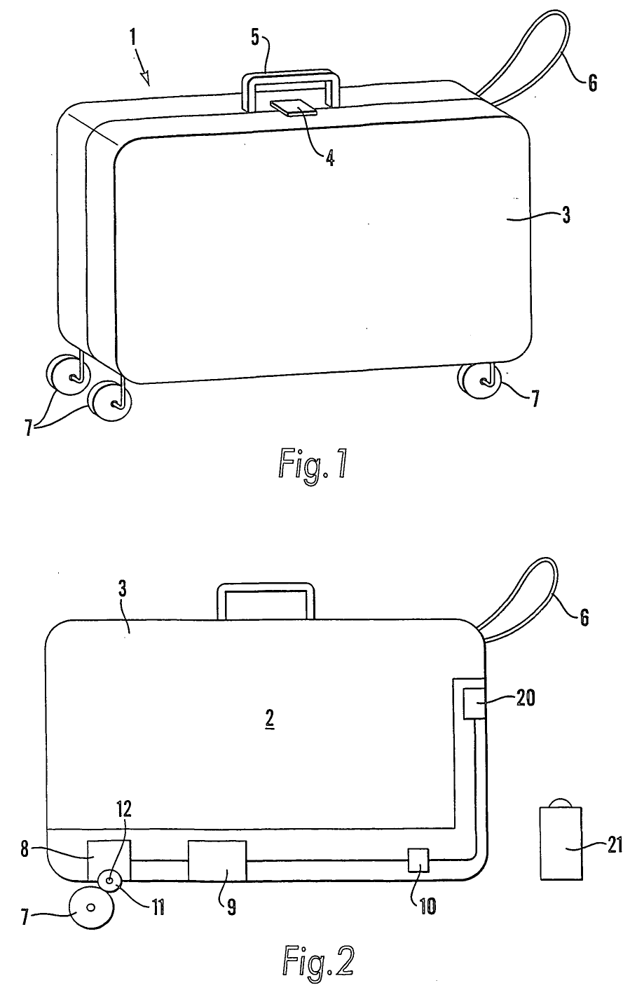

FIG. 1 is a perspective view of a suitcase; and

FIG. 2 is a schematic cross section.

Suitcase 1 comprises a compartment 2 for receiving material. Compartment 2 is bounded by walls 3 and in the illustrated embodiment is provided with a fastener 4 which may be a conventional suitcase locking arrangement. Suitcase 1 is provided with handle 5 and with an optional towing strap 6. Wheels 7 are provided. In the illustrated embodiment three wheels are provided in a triangular formation. It would, however be possible to provide a different number of wheels, for example, four could be provided. At least some of the wheels can be castors.

As herein before described the suitcase is conventional. However in accordance with the invention the suitcase is locomotive, that is, self propelled. This is achieved by providing a drive mechanism for driving one or more wheels in the form of an electric motor 8 powered by battery 9. In the illustrated embodiment controller 10 is provided to control electric motor 8, that is to start and stop the motor and, in some circumstances to control the speed of rotation of the electric motor 8. In the illustrated embodiment a friction roller 11 on the motor drive shaft 12 engages a wheel. Other arrangements such as meshed gears or chain drive will suggest themselves to the skilled worker. Preferably more than one wheel is powered in which case by differentially driving wheels on opposite sides of the suitcase one may steer the suitcase. Alternately one of the wheels may be steerable.

According to the invention there is provided a sensor 20 for sensing a signal received from a separate transmitter 21. Sensor 20 is connected to the controller 10 which controls the motor. The transmitter 21 transmits a signal to which the sensor is sensitive. By way of non-limiting example transmitter 21 could emit an infrared radiation signal, or a radio signal or an ultrasound signal. Desirably the transmitter transmits a coded pattern or a timed signal and the sensor includes a suitable decoder. This means that the sensor is not sensitive to a transmission from other similar transmitters in a situation such as an airport terminal where there may be more than suitcase and transmitter.

Controller 10 includes means to cause the suitcase to move so as to maximise the signal received from the transmitter. It will do this by moving as close to the transmitter as it can. If therefore the transmitter is carried on the person of a user, for example, in the pocket or purse of a user, the suitcase will follow the person without continuous manual control.

Clearly, more than one suitcase can be controlled by a user without having to lift them.

The invention is not restricted to the details of the foregoing example.

1. A self-propelled suitcase comprising:
i) a storage compartment (2)
ii) a plurality of wheels (7)
iii) means (8, 11, 12) for driving at least one wheel
iv) a sensor (20) for sensing a transmitted signal
v) means (10) for guiding the suitcase toward the source of the transmitted signal.
vi) a separate signal transmitter (21) for transmitting a signal to be detected by the sensor.

2. A suitcase as claimed in claim 1 wherein the signal transmitter is an infrared signal transmitter.

3. A suitcase as claimed in claim 1 wherein the signal transmitter is a radio frequency signal transmitter.

4. A suitcase as claimed in claim 1 wherein the signal transmitter is an ultrasound signal transmitter.

5. A suitcase is claimed in any of claims 2 to 4 wherein the signal transmitter transmits a coded signal and the sensor includes a decoder.

6. A suitcase as claimed in any one of the preceding claims wherein the signal transmitter transmits a timed signal.

7. A suitcase as claimed in any one of the preceding claims wherein said means (8, 11, 12) for driving at least one wheel comprise means for differentially driving wheels on opposite sides of the suitcase whereby the suitcase may be steered.
